(19) United States
(12) Patent Application Publication
(10) Pub. No.: US 2014/0208312 A1
(43) Pub. Date: Jul. 24, 2014

(54) Method, System, Device And Storage Medium For Restoring User System

(71) Applicant: TENCENT TECHNOLOGY (SHEZHEN) COMPANY LIMITED, Shenzhen (CN)

(72) Inventors: Haibo LIAO, Shenzhen (CN); Fuzhong SHENG, Shenzhen (CN); Peixuan CHEN, Shenzhen (CN)

(73) Assignee: TENCENT TECHNOLOGY (SHENZHEN) COMPANY LIMITED, Shenzhen (CN)

(21) Appl. No.: 14/211,499

(22) Filed: Mar. 14, 2014

Related U.S. Application Data
(63) Continuation of application No. PCT/CN2012/078030, filed on Jul. 2, 2012.

(30) Foreign Application Priority Data
Sep. 15, 2011 (CN) CN201110273271.0

(51) Int. Cl. G06F 9/445

(52) U.S. Cl. CPC G06F 8/61
USPC 717/178

(57) ABSTRACT

A service control is downloaded and installed. First software information installed by the user system is uploaded by the service control to a cloud server side. The first software information includes a software list, or the software list and personalized configuration files of each software. When needing to restore the user system, second software information of the user system is obtained from the cloud server side. Software of the user system is installed, based on the second software information obtained from the cloud server side.

### CROSS-REFERENCE TO RELATED APPLICATIONS

This application is a continuation of International Application No. PCT/CN2012/078030 filed on Jul. 2, 2012. This application claims the benefit and priority of Chinese Application No. CN201110273271.0 filed on Sep. 15, 2011. The entire disclosure(s) of (each of) the above application(s) is (are) incorporated herein by reference.

### FIELD

The present disclosure relates to computer technologies, and more particularly, to a method, system, device and storage medium for restoring a user system.

### BACKGROUND

This section provides background information related to the present disclosure which is not necessarily prior art.

When using a computer, an Operating System (OS) often must be re-installed, due to a crashed OS which results from failed software, failed hardware, virus infection, and so on. After re-installing the OS, all of the software installed in the original OS needs to be downloaded and installed once again as well, which requires additional time and energy. Some methods for restoring installed software already exist in the current market, which mainly include the following.

A first method is as follows: using a system restoring function carried by the OS. In accordance with the first method, it is necessary for a user to create a restore point, or it is necessary for a system to be set in the manner of automatically creating a restore point, so as to back up the system. When the user's OS has a problem, restore point states may be reestablished by using the system restoring functions. Deficiencies of the first method are as follows: more hardware space may be required; or the system restoring functions may not be used when the system crashes and the system cannot be entered normally; and for some problems resulting from a Trojan virus, the system restoring functions may not be used to implement the restoration process.

A second method is as follows: restore a system with hardware. Some brands of computer hardware may carry a restore card, or a user may purchase an independent restore card and install the restore card into a computer mainboard, so as to restore the system with hardware. The hardware may be restored back to the state stored by the restore card only if the computer is shutdown. The second method may also be utilized by Internet bars and public computers. For a Personal Computer (PC), the main deficiencies are as follows: settings and data documents stored by a user may be lost simultaneously due to system restoring; and a PC needs to be supported by independent hardware, as universal hardware may not be sufficiently robust.

A third method is as follows: restore a system with restoring software. Currently, popular system restoring software may include onekey RECOVERY NORTON GHOST, a restore wizard, and so on. The restoring software may be operated easily, which may initiate the restoring at a segment located by a backup system, when a computer has been infected by virus or system crashes, so as to restore the system to the backup state. The deficiencies of the third method are as follows: more hardware space is necessary to implement the backup; and when infected by a virus, the backup files may be infected simultaneously, such that the virus may be not totally removed after restoring.

Thus, it can be seen that when implementing the system restoring functions in the prior art, generally, more hard disk space may be necessary to implement system backup, or special hardware support may be necessary. Subsequently, hardware requirements may be higher. When the system is infected by a virus, local system backup files are also possibly infected by the virus simultaneously. Therefore, security of restored system may be relatively poor.

### SUMMARY

This section provides a general summary of the disclosure, and is not a comprehensive disclosure of its full scope or all of its features.

In view of above, the present disclosure provides a method, system, device and storage medium for restoring a user system, such that requirements of hardware used for restoring the user system may be reduced, and the security of a restored system may be improved.

Technical solutions of the present disclosure may be implemented as follows.

A method for restoring a user system, including:

downloading and installing a service control;

uploading, by the service control, first software information installed by the user system to a cloud server side, wherein the first software information includes a software list, or the software list and personalized configuration files about each software;

when needing to restore the user system, obtaining second software information of the user system from the cloud server side, and installing software of the user system, based on the second software information obtained from the cloud server side.

A system for restoring a user system, including a service control and a cloud server side, in which

the service control is to upload first software information of the user system to the cloud server side, obtain second software information of the user system from the cloud servers side, install software of the user system based on the second software information obtained from the cloud server side, in which the first software information includes a software list of the user system, or the software list and personalized configuration files about each software; and

the cloud server side is to back up the first software information of the user system.

A device for restoring a user system, including a memory, a processor in communication with the memory, and an interface, in which the memory stores an uploading instruction, an obtaining instruction and an installing instruction, which are executable by the processor,

the uploading instruction indicates to upload first software information of the user system to a cloud server side via the interface, wherein the first software information includes a software list of the user system, or the software list and personalized configuration files about each software;

the obtained instruction indicates to obtain second software information of the user system from the cloud server side, wherein the second software information includes a software installation package organized by the cloud server side based on the software list of the user system, or includes the software installation package and the personalized configuration files about each software; and

the installing instruction indicates to install software of the user system, based on the software installation package, or based on the software installation package and the personalized configuration files about each software.

Based on the foregoing the present disclosure may back up the original software confirmation of a system at a cloud server side. When needing to restore the user system, the present disclosure will obtain the second software information of the user system from the cloud server side and install software based on the obtained second software information. Since the first software information of the user system is stored in the cloud server side, local storage control of the user system may be saved, and the device card dedicated to restoring the system may be unnecessary. As a result, hardware requirements of the user system may be reduced. From another aspect, since the first software information is backed up in the cloud server side, the backup first software information may be not affected when the local user system is threatened by insecurity factors, e.g., the local user system is infected by a virus. As a result, the security of the restored system may be improved. Furthermore, if personalized configuration files of the user system are backed up by the cloud side, personalized configurations of the user system may also be restored.

The drawings described herein are for illustrative purposes only of selected embodiments and not all possible implementations, and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for restoring a user system, in accordance with an example of the present disclosure.

FIG. 2 is a flowchart illustrating a method for backing up first software information of a user system at a cloud server side, in accordance with an example of the present disclosure.

FIG. 3 is a flowchart illustrating a method for restoring a user system based on first software information backed up in a cloud server side, in accordance with an example of the present disclosure.

FIG. 4 is a schematic diagram illustrating structure of a system for restoring a user system, in accordance with an example of the present disclosure.

FIG. 5 is a schematic diagram illustrating structure of a device for restoring a user system, in accordance with an example of the present disclosure.

FIG. 6 is a schematic diagram illustrating another structure of a device for restoring a user system, in accordance with an example of the present disclosure.

FIG. 7 is a schematic diagram illustrating still another structure of a device for restoring a user system, in accordance with an example of the present disclosure.

Corresponding reference numerals indicate corresponding parts throughout the several views of the drawings.

### DETAILED DESCRIPTION

Example embodiments will now be described more fully with reference to the accompanying drawings.

Clear and complete descriptions about technical solutions provided by examples of the present disclosure will be presented in the following, accompanying the attached figures. The descriptions below are only some examples in the present disclosure. All other examples, which may be obtained by others skilled in the art, are protected under the scope of the present disclosure.

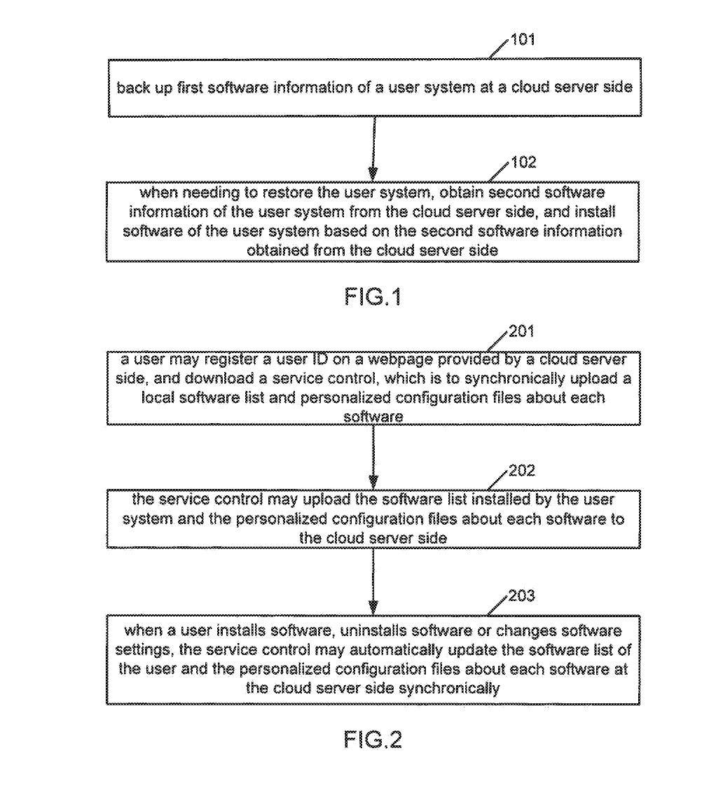

FIG. 1 is a flowchart illustrating a method for restoring a user system, in accordance with an example of the present disclosure.

As shown in FIG. 1, the method may include the following blocks.

In block 101, back up first software information of a user system at a cloud server side.

In the block, a user side may download and install a service control. The service control may upload the first software information installed by the user system to the cloud server side. The first software information may include a software list or the software list and personalized configuration files for each software. The cloud server side may back up the first software information.

In block 102, when needing to restore the user system, the present disclosure will obtain second software information of the user system from the cloud server side and install software of the user system, based on the second software information obtained from the cloud server side.

In FIG. 1, the service control may be utilized to synchronize the software list of the user system with the cloud server side. The service control may also be utilized by the cloud server side to obtain the second software information of the user system. Specifically, back up of the first software information of the user system in the cloud server side may include the following.

Download and install a service control, which is to upload a local software list, or the software list and personalized configuration files of each software. The service control is to upload the software list installed by the user system, and the personalized configuration files of each software to the cloud server side.

In regard to the time point when the service control uploads the first software information to the cloud server side, the present disclosure asserts that the service control may monitor operations regarding installing software, uninstalling software, or changing software settings executed by a user. When monitoring the foregoing operations, the service control may upload the software list of the user system and personalized configuration files of each software to the cloud server side.

In regard to the detailed contents regarding the first software information uploaded by the service control to the cloud server side, the present disclosure asserts that the first software information may include the software list of the user system or the software list and personalized configuration files of each software. The first software information may further include software change information for the user system.

The service control may upload the software list of the user system to the cloud server side, instead of software of the user system. From one aspect, transmission resources may be saved. From another aspect, since the cloud server side needs to store a huge amount of user first software information, the cloud server side may store the software list for each user, instead of the software. As a result, storage space for the cloud server may also be saved. In other words, regarding the huge amount of user first software information for each software, the cloud server only needs to store a small amount of backup (one backup), which is not necessary to store the software for each user.

Under the circumstances that the first software information includes the software list of the user system and the personalized configuration files of each software, when employing the method illustrated with FIG. 1, not only may each software installed by the user system be restored, but user personalized configurations of each software may also be restored.

In block 102, specifically, obtaining the second software information of the user system from the cloud server side may include the following. The cloud server side may organize a software installation package, based on the software list of the user system, and transmit the software installation package to the user system via the service control. The following may also be included: the cloud server side may transmit the personalized configuration files of each software to the user system via the service control. The process of the cloud server side organizing the software installation package based on the software list of the user system may include the following: the cloud server side may obtain an installation file corresponding to each software in the software list from a software warehouse and the cloud server side may encapsulate the installation file of each software into the software installation package.

The user system may install software based on the software installation package and execute personalized configurations about the software, based on the personalized configuration files.

When uploading the first software information of the user system to the cloud server side, the service control may upload a user identifier (ID), a software list installed by the user system, and personalized configuration files about each software to the cloud server side. Correspondingly, the cloud server side may take the user ID as an index, store the software list installed by each user system, and the personalized configuration files of each software. When obtaining the second software information of the user system from the cloud server side, the service control also needs to transmit the user ID to the cloud server side. Thus, the cloud server side may search out a corresponding software list, and the personalized configuration files of each software, based on the user ID, and transmit the software list and the personalized configuration files about each software searched out to the user system via the service control.

Modes for obtaining the user ID are not limited by the present disclosure. For example, the user ID may be obtained by registering on a webpage provided by the cloud server side, or may be generated based on a serial number of the service control downloaded.

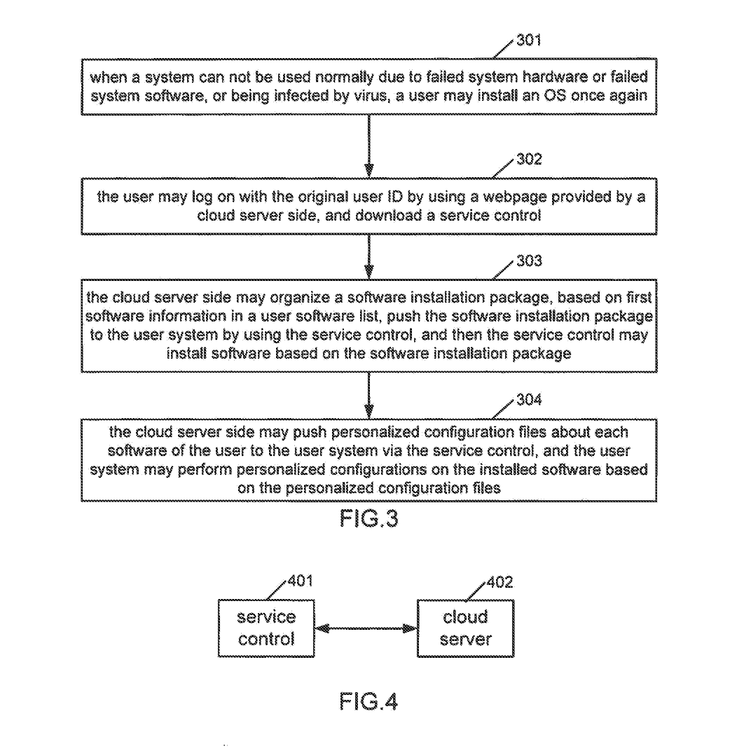

The method illustrated with FIG. 1 may be further described with examples shown in FIG. 2 and FIG. 3.

FIG. 2 is a flowchart illustrating a method for backing up first software information of a user system at a cloud server side, in accordance with an example of the present disclosure.

As shown in FIG. 2, the method may include the following blocks.

In block 201, a user may register a user ID on a webpage provided by a cloud server side and download a service control, which is to synchronously uploaded to a local software list and personalized configuration files of each software.

In block 202, the service control may upload the software list installed by a user system and the personalized configuration files of each software to the cloud server side.

In block 203, when the user installs software, uninstalls software, or changes software settings, the service control may automatically update the software list of the user and the personalized configuration files of each software to the cloud server side synchronously.

FIG. 3 is a flowchart illustrating a method for restoring a user system, based on first software information backed up at a cloud server side, in accordance with an example of the present disclosure.

As shown in FIG. 3, the method may include the following blocks.

In block 301, a system cannot be used normally due to failed system software or failed system hardware, or due to being infected by a virus, and a user may be required to install an Operating System (OS) once again.

In block 302, a user may log on by using an original user ID with a webpage provided by a cloud server side, and download a service control.

In block 303, the cloud server side may organize a software installation package based on the first software information in the user software list, and push the software installation package to the user system via the service control. The service control may install software based on the software installation package.

In block 304, the cloud server side may push the personalized configuration files for each software of the user to the user system via the service control. The user system may execute the personalized configuration on the installed software, based on the personalized configuration files.

The software installation package and the personalized configuration files may be transmitted altogether to the user system via the service control. Alternatively, the software installation package may be first transmitted via the service control. When the software has been installed, the personalized configuration files may then be transmitted.

Based on the foregoing method, the present disclosure also provides a corresponding system and device, which may refer to FIG. 4 and FIG. 5.

FIG. 4 is a schematic diagram illustrating structure of a system for restoring a user system, in accordance with an example of the present disclosure.

As shown in FIG. 4, the system may include a service control 401 and a cloud server 402.

The service control 401 is to upload first software information of a user system to a cloud server 402, obtain the second software information about the user system from the cloud server 402, and install software of the user system, based on the second software information obtained from the cloud server 402. The first software information may include a software list of the user system or the software list and personalized configuration files for each software.

The cloud server 402 is to back up the first software information of the user system.

The service control 401 may monitor operations for installing software, uninstalling software, or changing software setting executed by a user. When monitoring the foregoing operations, the service control 401 may upload the first software information to the cloud server 402, or upload software change information of the user system to the cloud server 402.

FIG. 5 is a schematic diagram illustrating structure of a device for restoring a user system, in accordance with an example of the present disclosure.

As shown in FIG. 5, the device may include an uploading module 501, an obtaining module 502, and an installing module 503.

The uploading module 501 is to upload first software information of a user system to a cloud server. The first software information may include a software list of the user system, or the software list and personalized configuration files for each software.

The obtaining module 502 is to obtain the second software information of the user system from the cloud server. The second software information may include a software installation package organized by the cloud server side based on the software list of the user system, or may include the software installation package and the personalized configuration files for each software.

The installing module 503 is to install software for the user system, based on the software installation package, or the software installation package and the personalized configuration files about each software.

The first software information may include the software list of the user system, or the software list and the personalized configuration files for each software.

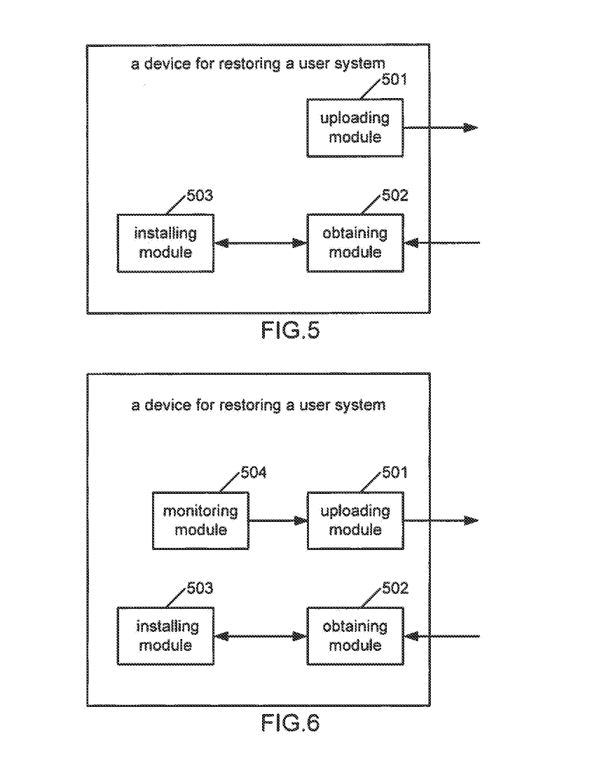

FIG. 6 is a schematic diagram illustrating another structure of a device for restoring a user system, in accordance with an example of the present disclosure. As shown in FIG. 6, the device may further include a monitoring module 504.

The monitoring module 504 is to monitor operations for installing software, uninstalling software, or changing software setting executed by a user.

When the monitoring module 504 has monitored the foregoing operations, the uploading module 501 is to upload the first software information to the cloud server side, or upload the software change information of the user system to the cloud server side.

The present disclosure also provides a storage medium, which may store a data processing program. When being executed, the data processing program may execute the following operations.

Upload first software information of a user system to a cloud server, in which the first software information may include a software list of the user system, or the software list and personalized configuration files for each software.

Obtain the second software information of the user system from the cloud server. The second software information may include a software installation package organized by the cloud server based on the software list of the user system, or the software installation package and the personalized configuration files for each software.

Install software for the user system based on the software installation package, or the software installation package and the personalized configuration files for each software.

Furthermore, the data processing program is to execute the following operations.

Monitor operations for installing software, uninstalling software, or changing software settings executed by a user.

When monitoring the foregoing operations, upload the first software information to the cloud server side, or upload software change information of the user system to the cloud server side.

The storage medium may use any type of recording mode, e.g., paper storage medium (such as paper tape), magnetic storage medium (such as floppy disk, hard disk, flash), optical storage medium (such as Compact Disk (CD)-Read-only Memory (ROM)), magneto-optical storage medium (such as MO), and so on.

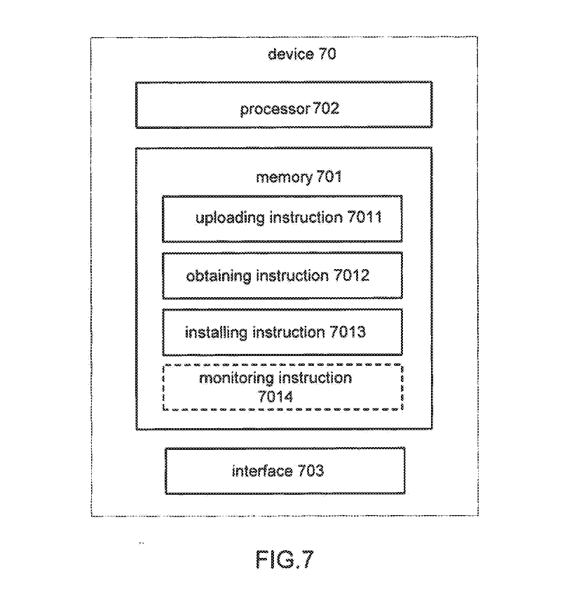

For example, FIG. 7 is a schematic diagram illustrating another structure of a device for restoring a user system, in accordance with an example of the present disclosure.

As shown in FIG. 7, the device 70 may include a memory 701, one or more processors 702 in communication with the memory 701, and an interface 703. To facilitate understanding, suppose there is one processor 702 in the example. The memory 701 stores an uploading instruction 7011, an obtaining instruction 7012, and an installing instruction 7013, which are executable by the processor 702.

The uploading instruction 7011 indicates to upload first software information of a user system to a cloud server via the interface 703. The first software information may include a software list of the user system, or the software list and personalized configuration files about each software.

The obtaining instruction 7012 indicates to obtain second software information of the user system from the cloud server. The second software information may include a software installation package organized by the cloud server side based on the software list of the user system, or may include the software installation package and the personalized configuration files for each software.

The installing instruction 7013 indicates to install software of the user system based on the software installation package, or based on the software installation package and the personalized configuration files for each software.

The first software information may include the software list of the user system, or may include the software list and the personalized configuration files for each software.

The memory 701 may further store a monitoring instruction 7014 executable by the processor 702.

The monitoring instruction 7014 indicates to monitor operations for installing software, uninstalling software, or changing software setting executed by a user.

When the foregoing operations have been monitored based on the monitoring instruction 7014, the uploading instruction 7011 further indicates to upload the first software information to the cloud server side, or upload the software change information of the user system to the cloud server side.

Based on the foregoing technical solutions, it can be seen that the present disclosure may achieve the following advantages.

The present disclosure may back up first software information installed in a user system at a cloud side (server side), which will not occupy local disk space. Meanwhile, the backed up first software information may be unaffected when the user system is infected by a virus or the user system crashes.

The present disclosure does not need to back up the software, which is only necessary to back up software installation list information at the cloud side. Subsequently, little storage space may be occupied and smaller data transmission network traffic is necessary.

In accordance with the technical solutions provided by the present disclosure, when restoring the software installed by a user, software personalized settings of the user may also be restored by backing up the personalized configuration files of each software in the software list installed by the user.

Since the user system needs to upload the software list information or the software list information and personalized configuration files instead of uploading the whole software package, the bandwidth may be saved. Further, since the cloud side is to receive a huge amount of user's first software information, different user first software information may be crossed (e.g., different users may install the same software). Subsequently, the cloud side does not need to actually store a software package for each user. Instead, the cloud side is only necessary to store a software list for each user, which may greatly save storage space of the cloud side.

The foregoing are only preferred examples of the present disclosure, which are not used for limiting the present disclosure. Any modifications, equivalent substitutions, and improvements made based on the claims of the present disclosure should be covered by the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for restoring a user system, comprising:
downloading and installing a service control;
uploading, by the service control, first software information installed by the user system to a cloud server side, wherein the first software information comprises a software list, or the software list and personalized configuration files about each software;
when needing to restore the user system, obtaining second software information of the user system from the cloud server side, and installing software of the user system, based on the second software information obtained from the cloud server side.

2. The method according to claim 1, wherein uploading by the service control the first software information installed by the user system to the cloud server side comprises:
monitoring, by the service control, operations about installing software, uninstalling software, or changing software settings executed by a user; and
when monitoring the operations about installing software, uninstalling software, or changing software settings executed by the user, uploading, by the service control, the software list of the user system, or the software list and the personalized configuration files about each software to the cloud server side, or uploading software change information of the user system to the cloud server side.

3. The method according to claim 1, wherein obtaining the second software information of the user system from the cloud server side comprises:
organizing, by the cloud server side, a software installation package, based on the software list of the user system, and transmitting the software installation package to the user system via the service control;
wherein installing the software of the user system comprises:
installing, by the service control, the software based on the software installation package.

4. The method according to claim 3, wherein obtaining the second software information of the user system from the cloud server side further comprises:
transmitting, by the cloud server side, the personalized configuration files about each software to the user system via the service control; and
wherein installing the software of the user system further comprises:
executing personalized configurations of the software, based on the personalized configuration files.

5. The method according to claim 1, wherein uploading by the service control the first software information installed by the user system to the cloud server side comprises:
uploading, by the service control, a user identifier (ID), the software list installed by the user system, and the personalized configuration files about each software to the cloud server side;
wherein the method further comprises:
taking, by the cloud server side, the user ID as an index, storing the software list installed by each user system, and the personalized configuration files about each software.

6. The method according to claim 5, wherein the user ID is obtained by registering on a webpage provided by the cloud server side, or is generated based on a serial number of the service control downloaded.

7. A system for restoring a user system, comprising a service control and a cloud server side, wherein
the service control is to upload first software information of the user system to the cloud server side, obtain second software information of the user system from the cloud servers side, install software of the user system based on the second software information obtained from the cloud server side, wherein the first software information comprises a software list of the user system, or the software list and personalized configuration files about each software; and
the cloud server side is to back up the first software information of the user system.

8. The system according to claim 7, wherein the service control is to monitor operations about installing software, uninstalling software, or changing software settings executed by a user;
when monitoring the operations about installing software, uninstalling software, or changing software settings, uploading, by the service control, the first software information to the cloud server side, or uploading software change information of the user system to the cloud server side.

9. A device for restoring a user system, comprising a memory, a processor in communication with the memory, and an interface, wherein the memory stores an uploading instruction, an obtaining instruction and an installing instruction, which are executable by the processor,
the uploading instruction indicates to upload first software information of the user system to a cloud server side via the interface, wherein the first software information comprises a software list of the user system, or the software list and personalized configuration files about each software;
the obtaining instruction indicates to obtain second software information of the user system from the cloud server side, wherein the second software information comprises a software installation package organized by the cloud server side based on the software list of the user system, or comprises the software installation package and the personalized configuration files about each software; and
the installing instruction indicates to install software of the user system, based on the software installation package, or based on the software installation package and the personalized configuration files about each software.

10. The device according to claim 9, wherein the memory further stores a monitoring instruction executable by the processor, and the monitoring instruction indicates to monitor operations about installing software, uninstalling software, or changing software settings executed by a user; and
when monitoring the operations about installing software, uninstalling software, or changing software settings based on the monitoring instruction, the uploading instruction further indicates to upload the first software information to the cloud server side, or upload software change information of the user system to the cloud server side.
